(19) United States
(12) Patent Application Publication
(10) Pub. No.: US 2007/0250531 A1
(43) Pub. Date: Oct. 25, 2007

(54) System and Method of Web Browser-Based Document and Content Management

(75) Inventors: Jana M. Wiggins, Winter Haven, FL (US); David E. Wiggins, Winter Haven, FL (US); Sarel Johannes Botha, Lakeland, FL (US)

Correspondence Address: AKERMAN SENTERFITT, P.O. BOX 3188, WEST PALM BEACH, FL, 33402-3188, US

(73) Assignee: Document Advantage Corporation, Winter Haven, FL (US)

(21) Appl. No.: 11/738,766

(22) Filed: Apr. 23, 2007

Related U.S. Application Data
(60) Provisional application No. 60/745,498, filed on Apr. 24, 2006.

(51) Int. Cl. G06F 7/00; G06F 17/00; G06F 17/30; G06F 3/00

(52) U.S. Cl. 707/102; 707/104.1; 715/751; 707/200

(57) ABSTRACT

A method and system for managing documents and content is provided. The method and system can include a management application hosted in a data center and access to the management application for a user in a remote location. The access can be provided by way of a web browser over the internet. The management application can capture, retrieve and archive the documents and content. Documents and content can be added to the system by way of a drag and drop interface.

### CROSS-REFERENCE TO RELATED APPLICATIONS

This application claims priority to U.S. Provisional Application Ser. No. 60/745,498, filed Apr. 24, 2006, the entire contents of which are incorporated herein by reference.

### FIELD OF THE INVENTION

The invention relates to a system and method of providing document and content management and, more particularly, to a Web browser-based document and content management suite.

### BACKGROUND OF THE INVENTION

Various types of information management systems exist, including document management systems and content management systems. A document management system (DMS) is an application that is used to track and store images of paper or electronic documents. A paper document is scanned and the image of the paper document is stored in a database. Optical character recognition can be performed on the image to provide editable and/or searchable text that is stored along with the image. For ease of retrieval, the image is typically assigned a descriptive name and can include a date of creation and/or date of modification.

Another type of information management system is a content management system (CMS). A CMS is an application for organizing and facilitating collaborative creation of documents and other content. A CMS supports creation, management, distribution, publishing, and discovery of information, such as corporate information. A CMS can be a Web-based application that is used for managing web sites and web content, and requires special client software to be loaded onto a client terminal for editing and constructing content. A CMS also can provide tools for managing the structure of web sites, the appearance of the published pages, and the navigation provided to users. Within an organization, an enterprise content management systems (ECMS) can be provided to combine a central content management system with other tools to manage a full range of content that exists within the organization.

While web-based applications that are accessed via web browsers do exist, known web-based applications do not provide integrated features. A system is needed that provides Web browser-based applications having integrated features for performing various functions.

### SUMMARY OF THE INVENTION

Various aspects of the invention overcome at least some of these and other drawbacks of existing systems. According to one embodiment in accordance with inventive aspects, a Web browser-based enterprise document and information management suite is provided that can capture, retrieve, route via business rules, process and/or archive objects. The suite can include a single application that enables users to access objects while simultaneously collaborating via a network, such as the Internet.

According to another embodiment, a plurality of client terminal devices can be coupled to one or more servers. The client terminal devices can include various modules, including a user interface module, an authentication module, a communications module, a presence module, a drag-and drop module, a graphical workflow builder module, and/or other modules. The server can include various modules, including an authentication module, a registration module, a presence module, a workflow engine module and/or other modules.

According to one embodiment, the client terminal devices and/or server can include presence modules that maintain status information regarding registered users. Status information can include whether the registered users are operating online or offline, whether the online registered users are active or inactive, and/or other status information of registered users. The presence modules may perform other functions.

According to another embodiment, the client terminal devices can include a graphical builder module to enable users to design, build, edit and implement custom workflow instructions. The graphical builder module can perform other functions.

According to one embodiment, the server can include an instant messaging module or other messaging module. The instant messaging module can be integrated within the enterprise document system and/or the enterprise content management system.

According to another embodiment, document version control features can be provided to include check in, check out, modification alerts and other document version control features. Users can subscribe to a notification service that provides a notification if a selected object or document is viewed, updated, or deleted. The user can also be notified if the index record for the object has been modified. The user can also be notified if new documents are added to the repository.

According to another embodiment, an audit record feature can be provided that tracks user activities such as logging in, searching, reading files, checking out files, checking in files, sending messages, receiving and viewing messages, receiving workflow items, acting on workflow items, adding documents to the system, exporting documents from the system, printing, and numerous other activities.

According to another embodiment, the Web browser-based document management system can include an integrated Wiki. The Wiki is integrated within the Web browser-based document management system to enable data recording and tracking of revisions within objects.

According to one embodiment, a Web browser-based document management system can be provided that includes an intermediate layer between structured indexing and the database. The intermediate layer allows custom modules to be provided into the document management system to enable monitoring of database manipulations search requests, index submissions and other database manipulations. The intermediate layer also allows the application to communicate with various database systems without programming specifically for those databases.

According to another embodiment, a method of performing Web browser-based enterprise document management is provided. A determination is made regarding whether or not a desired object is stored in the system. If an object is not stored in the system, the object can be scanned within the Web browser-based enterprise document management system. For documents that are stored as images in the Web browser-based document management system, a global search can be performed to find the object.

After an object is scanned or after a stored object is located, workflow instructions can be established for the object. The workflow instructions can be specific to a step and can identify a path or paths that the object travels to arrive at the selected step. The workflow instructions can enable users to identify what is expected of the user when accessing the object. Document version control features can be provided to include check in, check out, modification alerts and other document version control features.

The embodiments described herein provide numerous advantages over, and avoid many drawbacks of, prior systems. These and other objects, features, and advantages of the invention will be apparent through the detailed description of the embodiments and the drawings attached hereto. It is also to be understood that both the foregoing general description and the following detailed description are exemplary and not restrictive of the scope of the invention. Numerous other objects, features, and advantages of the invention should become apparent upon a reading of the following detailed description when taken in conjunction with the accompanying drawings, a brief description of which is included below.

### BRIEF DESCRIPTION OF THE DRAWINGS

The drawings appended hereto are intended to illustrate contemplated embodiments of the invention. The drawings are not intended to limit the invention solely to the embodiments illustrated and described.

FIG. 1 illustrates a system diagram according to one embodiment of the invention.

FIG. 2 illustrates a flow chart according to one embodiment of the invention.

FIG. 2a illustrates an exemplary screen-shot of a user interface according to one embodiment of the invention.

FIG. 3 illustrates an exemplary screen-shot of a user interface according to another embodiment of the invention.

FIG. 4 illustrates an exemplary screen-shot of a user interface according to yet another embodiment of the invention.

FIG. 5 illustrates an exemplary screen-shot of a user interface according to yet another embodiment of the invention.

FIG. 6 illustrates an exemplary screen-shot of a user interface according to yet another embodiment of the invention.

FIG. 7 illustrates an exemplary screen-shot of a user interface according to yet another embodiment of the invention.

FIG. 8 illustrates an exemplary screen-shot of a user interface according to yet another embodiment of the invention.

FIG. 9 illustrates an exemplary screen-shot of a user interface according to yet another embodiment of the invention.

### DETAILED DESCRIPTION OF THE INVENTION

Organizations typically store collective knowledge across various storage devices, wherein the collective knowledge may be placed in different types of document archives. Additionally, organizations may store the collective knowledge in non-compatible electronic documents within non-integrated systems. In one embodiment in accordance with aspects of the invention, a system can provide a Web browser-based enterprise document and information management suite that offers secure, user friendly, and cross platform products for capturing, retrieving, routing, processing, and/or archiving objects. Objects can include documents, images, email messages, instant messages, video and/or other objects. The system can provide a single application that enables users to access objects while simultaneously collaborating via a network, such as the Internet.

The exemplary embodiment of the Web browser-based document and content management suite can have integrated functionality, including one or more of drag and drop indexing, scanning, global document search, on-line presence of users, collaboration and rules-based business process management, among other functions. The application can be delivered to the customer as “Software as a Service” (SaaS) or “On Demand.” The software can be hosted in a remote, secure data center and can be delivered to the customer via a web browser over a network, such as the internet. The software can be multi-tenant, so that one instance of the software supports many customers. The multi-tenant feature of the software can reduce the complexity of hosting and managing the application. By delivering the software via SaaS, the back-end platform including the server, database, and operating system can be controlled, which requires only one version of the source code to be supported, resulting in a reduction in complexity. The customer can gain significant advantages with SaaS delivery model, since they no longer have to purchase server hardware, software, and databases. The customer also doesn't have to worry about updates to the application because the support team can process any needed updates.

While specific embodiments of the invention are discussed herein and are illustrated in the drawings appended hereto, the invention encompasses a broader spectrum than the specific subject matter described and illustrated. As would be appreciated by those skilled in the art, the embodiments described herein provide but a few examples of the broad scope of the invention. There is no intention to limit the scope of the invention only to the embodiments described herein.

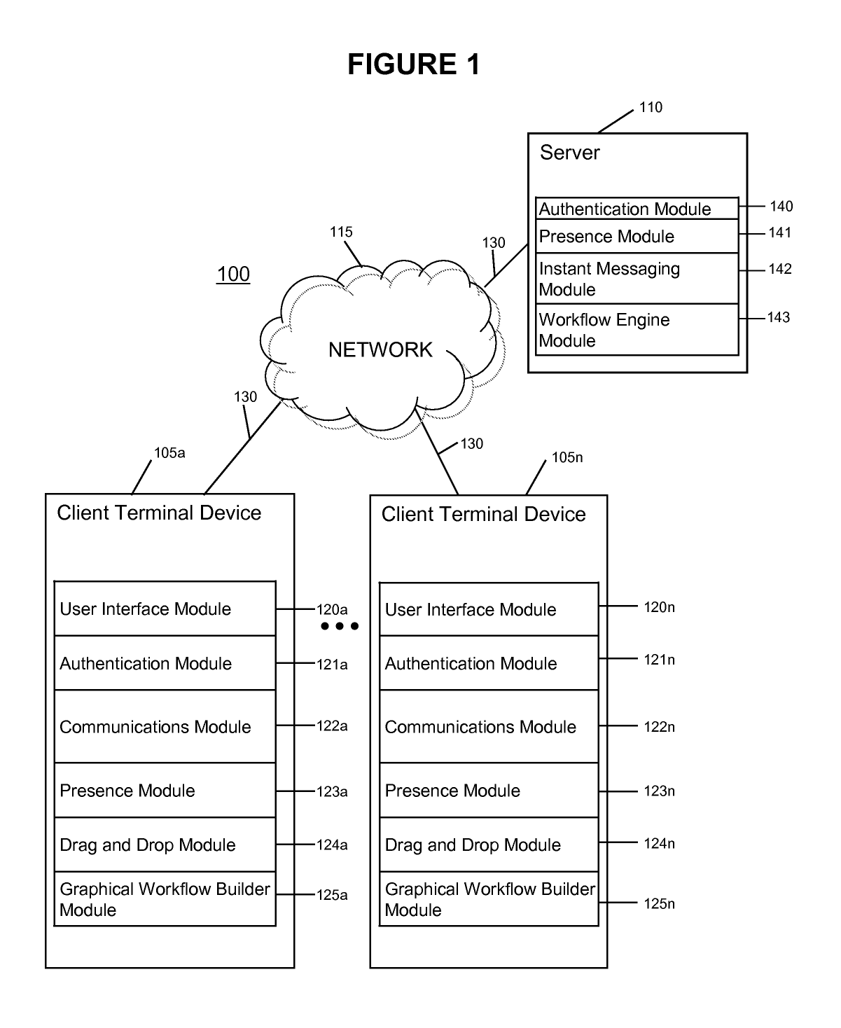

FIG. 1 illustrates system architecture 100 according to one embodiment. Client terminal devices 105a-105n (herein client terminal devices 105) and server(s) 110 can be connected via a wired network, a wireless network or a combination of a wired network and a wireless network. Client terminal devices 105 can include any number of client terminal devices including personal computers, laptop computers, hand-held computers, palmtops, personal digital assistants (PDAs), and/or other client terminal devices. Communications can be directed from one client terminal device 105 to another client terminal device 105 via network 115. Network 115 can include the Internet and/or other networks.

According to one embodiment, client terminal devices 105 can include several components, including a processor, RAM, a USB interface, a telephone interface, microphone, speakers, a stylus, a computer mouse, a wide area network interface, a local area network interface, a hard disk drive, a wireless communication interface, a DVD/CD reader/burner, a keyboard, a flat touch-screen display, a computer display, and/or other components. According to another embodiment, client terminal devices 105 can include, or be modified to include, software that can operate to provide document and information management functionality

According to one embodiment, client terminal devices 105 and/or server 110 can include several modules. The modular construction facilitates adding, deleting, updating and/or amending modules therein and/or features within modules. Client terminal devices 105 can include various modules, including a user interface module 120, an authentication module 121, a communications module 122, a presence module 123, a drag-and drop module 124, a graphical workflow builder module 125, and/or other modules. Server 110 can include various modules, including an authentication module 140, a registration module 141, a presence module 142, a workflow engine module 143 and/or other modules. It should be readily understood that a greater or lesser number of modules might be used. One skilled in the art will readily appreciate that the invention may be implemented using individual modules, a single module that incorporates the features of two or more separately described modules, individual software programs, and/or a single software program.

According to one embodiment, user interface modules 120a-120n (hereinafter user interface modules 120) can support several features including a display screen, a voice recognition system, a speaker, a microphone, input buttons, and/or other features. According to one embodiment, select functions can be implemented by positioning an indicator over selected icons and manipulating an input receiving device, such as a mouse, a keyboard, or other input receiving devices. According to another embodiment, select functions can be implemented using a voice recognition system to enable hands-free operation.

With regard to user authentication, authentication modules 121a-121n (hereinafter user authentication modules 121) can employ one of several different authentication schemes, as would be appreciated by those skilled in the art. According to one embodiment, user authentication modules 121 can prompt users to input alphanumeric code or other identifying information. According to another embodiment, user authentication modules 121 can prompt users to provide biometric information (e.g., a thumbprint through a fingerprint scanner) or other suitable identifying information. If the user is not identified, then the user can be invited to resubmit the requested identification information or to take other action.

According to one embodiment, client terminal devices 105 can include communication modules 122a-122n (hereinafter communication modules 122) for enabling client terminal devices 105 to communicate with systems, including other client terminal devices, servers 110 and/or other systems. Client terminal devices 105 can communicate via communications media 130, such as, for example, any wired and/or wireless media.

The identifying information can be forwarded to server 110 to perform various functions. According to one embodiment, authentication module 140 can be located at server 110 to receive identifying information that is entered into a corresponding client terminal device 105 via authentication module 121. Authentication module 140 can compare the identifying information with existing records and operate as a gatekeeper to system 100. In one embodiment, authentication module 140 can attempt to authenticate a registered user by matching the entered identifying information with access information that exists on server 110. If the user is not authenticated, then the user can be invited to resubmit the requested identifying information or take other action. If the user is authenticated, then server 110 can perform other processing. For example, client terminal device 105 can receive information from server 110 and/or from another authenticated client terminal device.

According to one embodiment, communications between client terminal devices 105 and server 110 can occur substantially in real-time if the system 100 is connected with network 115. According to another embodiment, the communications can be delayed for an amount of time if, for example, one or more client terminal devices 105 and/or server 110 are not connected to network 115. One of ordinary skill in the art will appreciate that communications can be conducted in various ways and among various devices.

According to one embodiment, any requests and/or changes that are made to objects while client terminal devices 105 and/or server 110 are not connected to network 115 can be stored and propagated from/to the offline device when the device is re-connected to network 115. For example, the request and/or change that is made to objects can be stored in a storage device associated with server 110. Alternatively, the request and/or change that is made to objects can be stored in a memory that is associated with client terminal devices 105.

Upon reconnection to network 115, information stored in storage device and/or memory that is associated with server 110 and/or client terminal devices 105 can be forwarded to the corresponding target client terminal device. However, during a time that the target client terminal device 105 and/or server 110 are not connected to network 115, requests and/or changes that are made to objects can remain in the corresponding client terminal device 105 and/or server 110 for dissemination when the devices are re-connected to network 115.

Communications via network 115 can be implemented using current and future language conventions and/or current and future communications protocols that are generally accepted and used for generating and/or transmitting messages over network 115. Language conventions can include Physical Markup Language (“PML”), Hypertext Markup Language (“HTML”), extensible Markup Language (“XML”), and/or other language conventions. Communications protocols can include Hypertext Transfer Protocol (“HTTP”), TCP/IP, SSL/TLS, FTP, GOPHER, and/or other protocols.

According to one embodiment, client terminal devices 105 can include presence modules 123a-123n (hereinafter presence modules 123) that maintain status information regarding registered users. According to another embodiment, server 110 can include presence module 141 that maintains status information regarding registered users. According to yet another embodiment, status information can be maintained at both presence module 123 and presence module 141.

According to one embodiment, presence modules 123, 141 can detect status information of registered users, such as whether the registered users are operating online or offline, whether the online registered users are active or inactive, and/or other status information of registered users. Additionally, presence modules 123, 141 can detect a type of network connection associated with the registered user, such as a dialup connection, a broadband connection, or other type of network connection. According to another embodiment, presence modules 123, 141 can identify a list of registered users (e.g., friends) that are associated with the authenticated user and can determine which, if any, registered users are currently available for immediate communication, including collaboration.

According to one embodiment, immediate communication can be performed between two or more client terminal devices 105 using instant messaging module 142, or other messaging module. Instant messaging module 142 can be integrated within the enterprise document management system and/or the enterprise content management system. According to one embodiment, information that is exchanged via the instant messaging module 142 can be recorded and can be accessible within the enterprise document management system and/or the enterprise content management system.

According to one embodiment, client terminal devices 105 can include drag and drop modules 124a-124n (hereinafter drag and drop modules 124) that manipulate documents, content and other data, including adding documents to the system 100, by way of a drag and drop interface.

According to one embodiment, client terminal devices 105 can include workflow graphical builder modules 125a-125n (hereinafter workflow graphical builder modules 125) that enable users to design, build, edit and implement custom workflow instructions. According to another embodiment, server 110 can include workflow engine module 143 that enables users to design, build, edit and implement custom workflow instructions. The workflow instructions can be specific to a step and can identify a path that the object traveled to arrive at the selected step. The workflow instructions enable users to identify what is expected of the user when accessing the object.

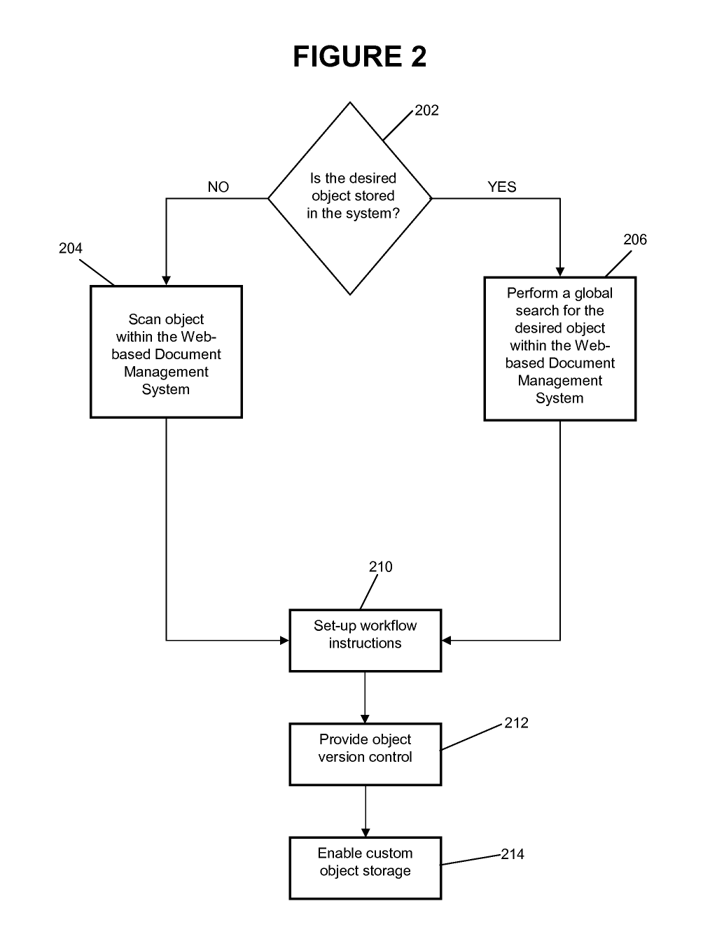

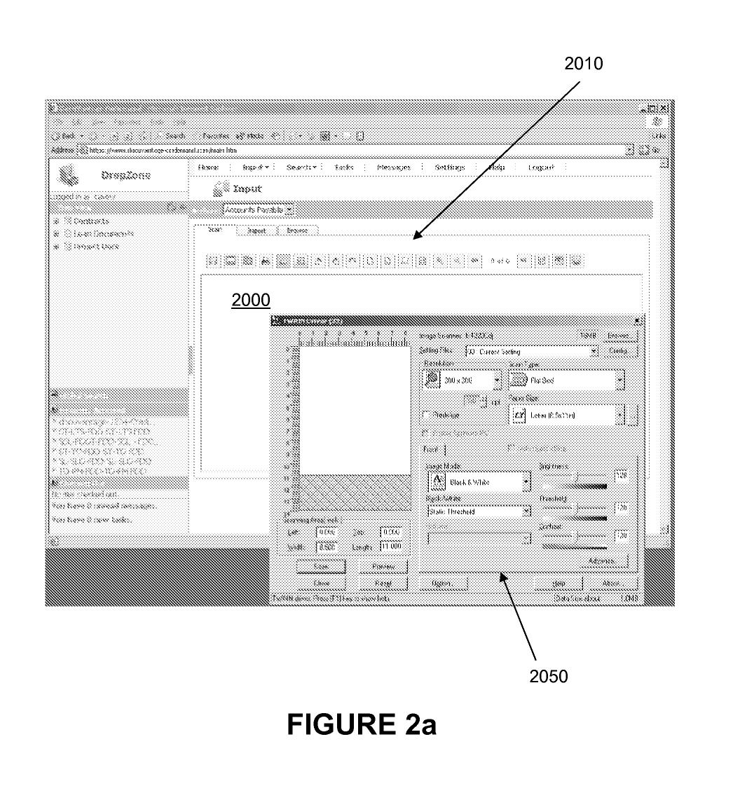

FIG. 2 illustrates a flow diagram of a generalized method 200 of performing Web browser-based enterprise document management according to one embodiment of the invention. In operation 202, a determination is made regarding whether or not a desired object is stored in the system 100.

If an object is not stored in the system 100, the object can be scanned within the Web browser-based enterprise document management system in operation 204. As illustrated in FIG. 2a, an exemplary user interface 2000 is shown for the scanning operation 204. The interface 2000 can include a scanning toolbar 2010 with various scanning functions to facilitate operation. According to one embodiment, a Java Applet and Java TWAIN scanner driver can be integrated with a Java enterprise document management system to enable the object to be directly scanned into the Web browser-based enterprise document management application. For example, a Java TWAIN scanner driver can be provided in pop-up window 2050, and can include various control functions including resolution, brightness, threshold, contrast and the like.

By contrast, known Web-based document management systems use non-Web-based scanning applications to scan and store document images. Alternatively, known Web-based document management systems that support Web-based scanning applications require users to install a browser plug-in to provide a scanning application, wherein the scanning application is not integrated within the enterprise document management system. Since known non-Web-based scanning applications and Web-based scanning applications are not integrated with Web-based document management system, a multi-step operation is needed to scan documents in one step and export the scanned images in a second step. The multi-step image scanning and exporting introduce inefficiencies to the Web-based document management system.

For documents that are stored as images in the Web browser-based document management system 100, a global search can be performed in operation 206. According to one embodiment, the global search can join all of the index tables and all of the text search libraries into a single query function. As a result, the user does not need to know where the desired object is stored within the Web browser-based document management system 100. By contrast, known document management systems typically divide objects into various repositories based on attributes associated with the objects. Under these known systems, a search is performed within a specific repository, so if a user is not familiar with the document management system 100, a same search can need to be performed over various repositories.

By contrast, known Web-based document management systems do not support drag-and-drop functionality within the Web-based document management system. According to one embodiment, a Java Applet can be integrated with the Java-based Web browser-based document management system 100. Using Java allows the objects to be stored on various platforms including Windows, Linux, Unix, Mac Server and other platforms. A single source code base can be provided that is used for multiple platforms. According to one embodiment, network and database transparency can be provided to enable operations using Oracle, SQL Server, My SQL, and other databases.

After an object is scanned in operation 204 or after a stored object is located in operations 206, workflow instructions can be established for the object in operation 210. According to one embodiment, document version control features can be provided in operation 212 to include check in, check out, modification alerts and other document version control features. According to one embodiment, the Web browser-based document management system 100 provides check in and check out version control by saving a requested object to a users folder within server 110. As a result, a single version of the object will be maintained on server 110, rather than allowing multiple to exist on client terminal devices 105. According to another embodiment, users can subscribe to a notification service that provides a notification if a selected object is updated by another user. The notification service can provide notification using an instant messaging service, email service or other notification.

According to one embodiment, custom object storage can be provided in operation 214. Users can add tags to objects without altering an approved index for the object. The tags provide additional data for searching objects, thereby expanding object searches beyond index fields and content. The invention can also enhance existing index searching results by enabling a spell checker to be run on the index fields.

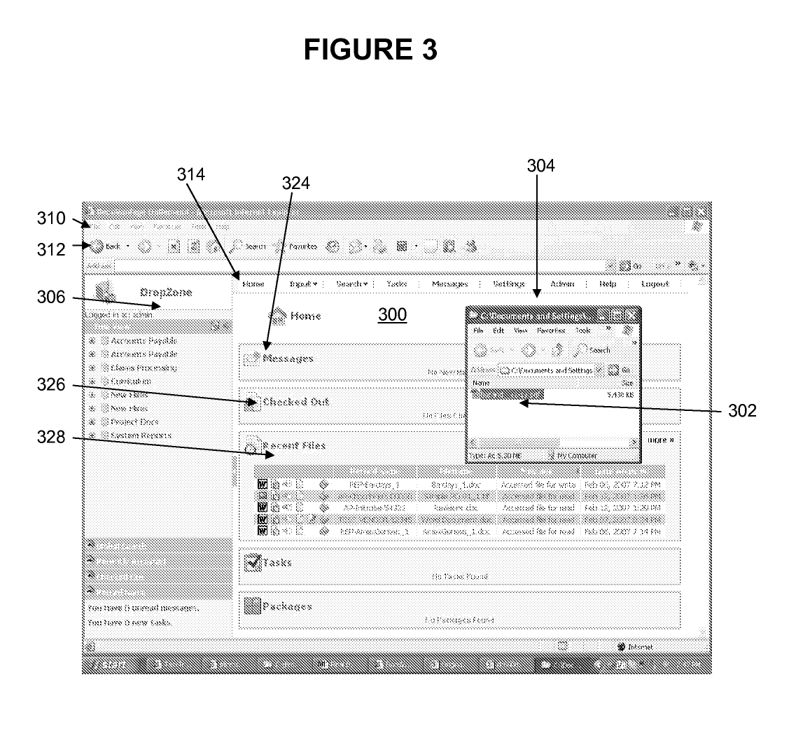

FIG. 3 illustrates an exemplary layout of a client side application user interface (UI) 300. Application UI 300 can include toolbars 310, 312, 314 and various panes 324, 326, 328 that illustrate several aspects and features of the application. According to one embodiment, application UI 300 can include one or more components, such as various panes, toolbars and drop zone 306. For example, application UI 300 can include Messages pane 324, Checked Out pane 326, and Recently Accessed pane 328. Other panes can be provided.

According to one embodiment, toolbar 310 can include various pull down menus that enable several operations to be performed by the browser application. For example, toolbar 310 can include pull down menus related to File, Edit, View, Favorites, Tools and Help operations. Furthermore, toolbar 312 can include several shortcut buttons for performing various operations such as accessing a previous web page, accessing a next web page, screen refreshing, printing and other operations. Toolbar 314 can include several buttons for performing actions within the Web browser-based document management system 100, such as accessing a Home page, accessing an Input page, accessing a Search page, accessing a Reports page, accessing an Administration page, accessing a Help page, and performing a Logout. Other buttons can be provided in toolbars 310,312,314.

Messages pane 324 enables the registered users to select message objects for review. The contents of the selected message objects can be displayed in a viewing pane. Checked Out pane 326 enables the registered users to view checked out objects for review. The contents of the selected checked out objects can be displayed in a viewing pane. Recently Accessed pane 328 enables the registered users to view recently accessed objects for review. The contents of the selected recently accessed objects can be displayed in a viewing pane. FIG. 3 also illustrates test document object 302 that can be selected from test document folder 304.

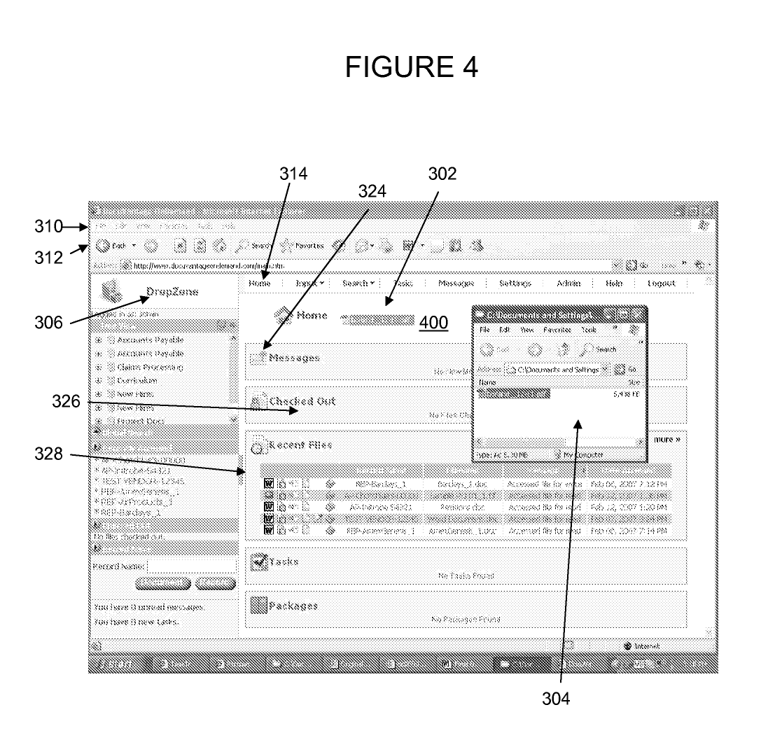

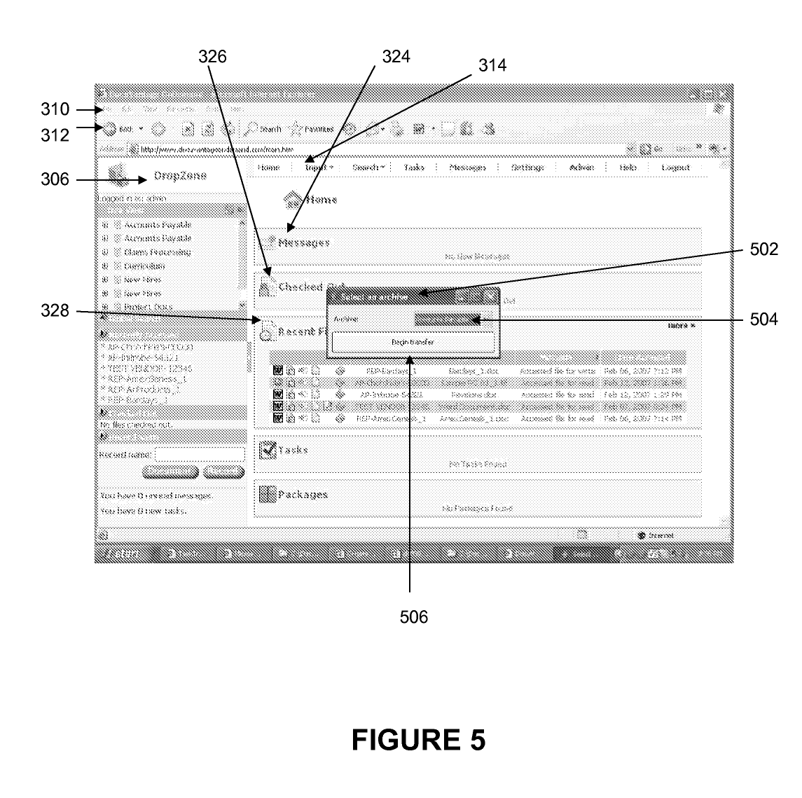

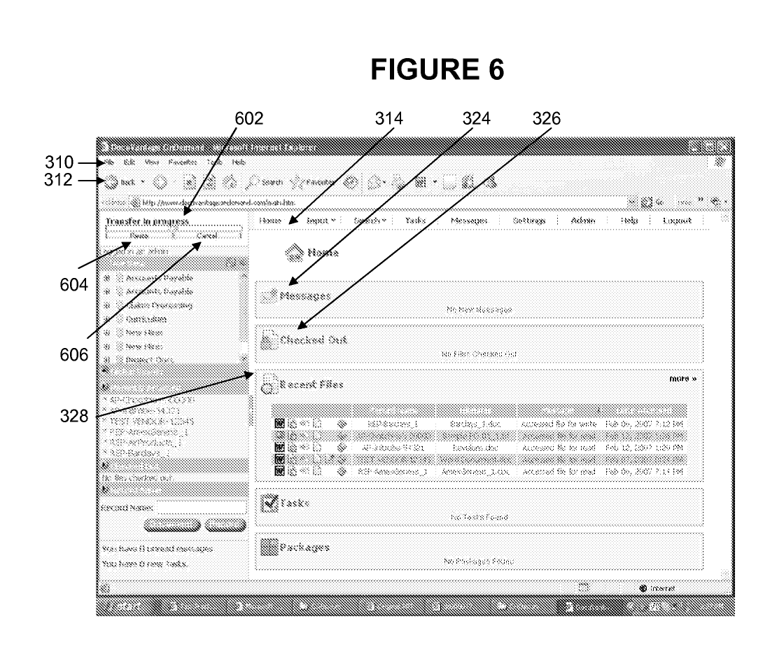

As illustrated in FIG. 4, test document object 302 can be dragged and dropped into a drop zone 306 that is located in a selected area on the web page 400. After the test document object 302 is dropped, FIG. 5 illustrates a Storing pane 502 that is presented to include a drop down menu 504 having a list of repository names that can be used to associate the test document object 302 with a database record. After selection of the appropriate repository from drop down menu 504, a begin transfer button 506 can be selected to start the transfer of the test document object 302. Test document object 302 can be uploaded to a predetermined server and can be stored in a repository. FIG. 6 illustrates a transfer in progress pane 602 that provides an indication of a percentage completion of the transfer. Transfer in progress pane 602 can include a pause button and a cancel button 606.

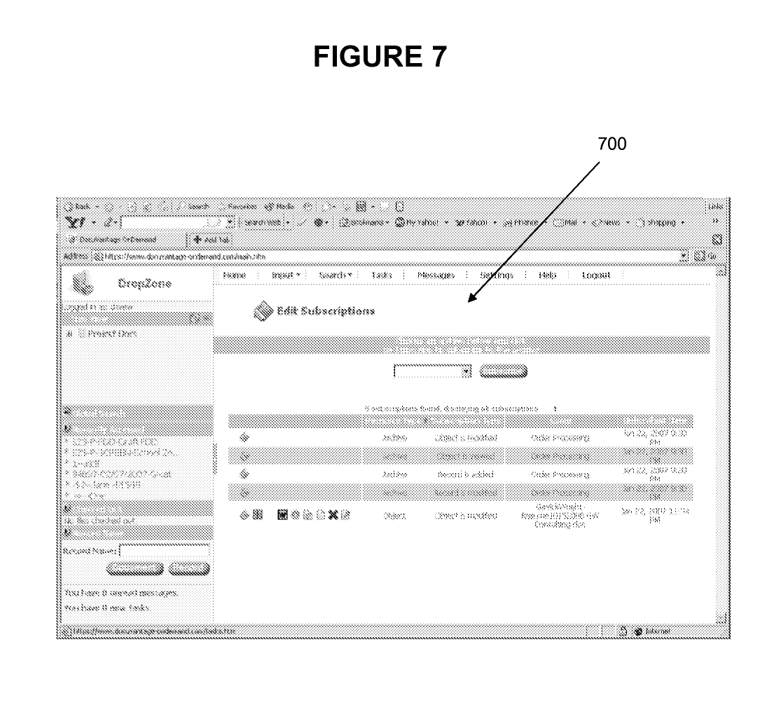

FIG. 7 illustrates the user's list of Subscriptions in a Subscribed documents pane 700 that enables the registered users to view subscribed document objects for review. The contents of the selected subscribed document objects can be displayed in a viewing pane. Additional information such as the resource type, subscription type, name, and subscription date can be displayed.

An indexing screen can be provided after the file is uploaded. The user can enter the index values and select the appropriate button. The Index button saves the document object in the repository, the Tasks Button shows the user a list of tasks waiting for their actions and to which they can add the document that was just indexed. The Processes Button allows the user to attach the document to a workflow and begin the routing process.

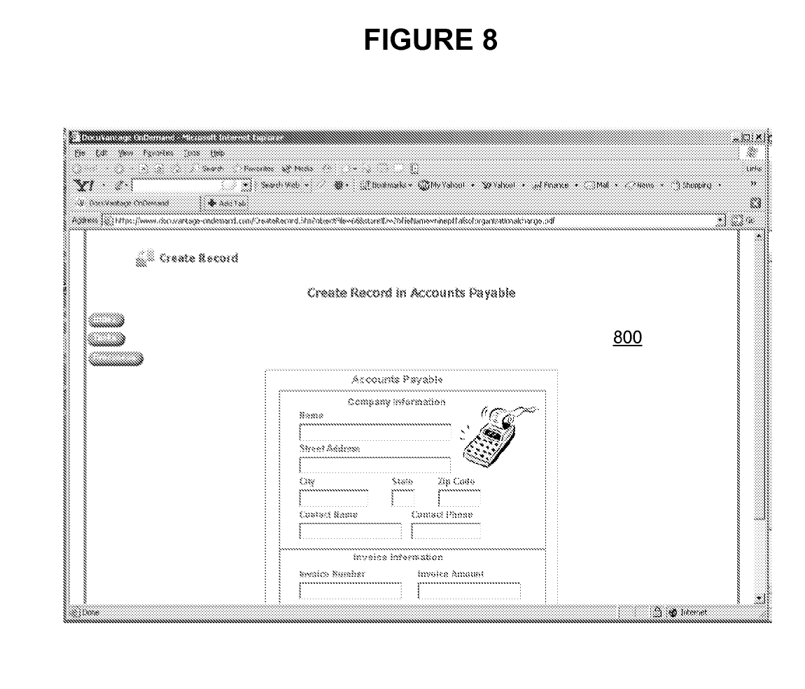

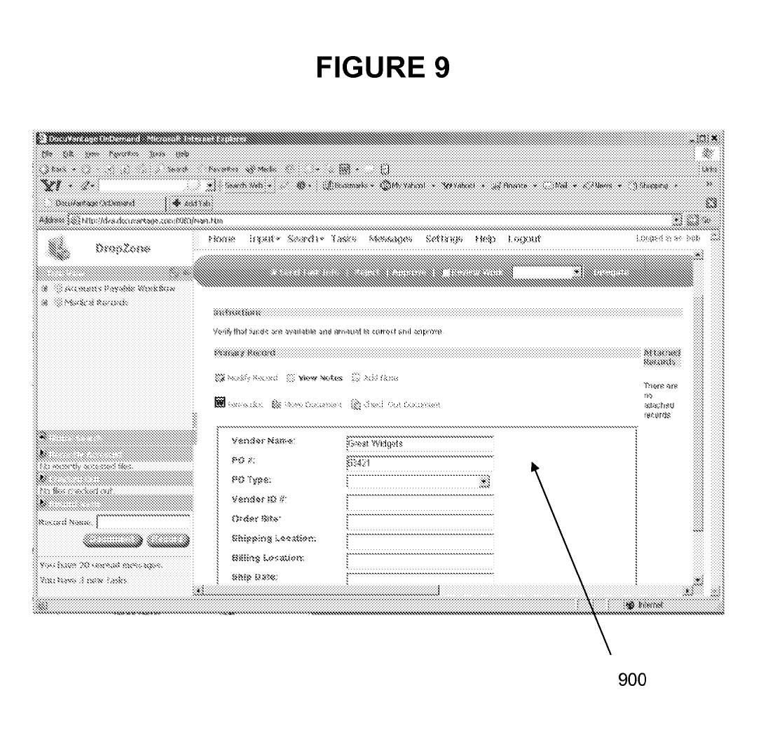

As illustrated in FIGS. 8 and 9, a sample accounts payable record pane 800 and a sample accounts payable funds verification pane 900 are provided that allow a user to provide various information, including contact and invoice information. A user can also verify that funds are available, and the amount is correct and approved

According to another embodiment, server 110 can provide an audit record feature that tracks user activities such as logging in, searching, reading files, checking out files, checking in files, sending messages, receiving and viewing messages, receiving workflow items, acting on workflow items, adding documents to the system 100, exporting documents from the system, printing, and numerous other activities. The tracked user activities can be used in compliance audit monitoring, among other purposes.

According to another embodiment, the Web browser-based document management system 100 can include an integrated Wiki. A Wiki can include a web site that enables registered users to add, remove or otherwise modify object content, thereby providing an effective tool for collaborative writing. According to one embodiment, the Wiki is integrated within the Web browser-based document management system 100 to enable data recording and tracking of revisions within objects. By contrast, known document management systems enable access to Wikis that are external to the document management systems, so that data is not recordable and/or trackable to the system. With the growing use of Wilds for collaboration within companies, managing the Wikis in a controlled environment aides in maintaining compliance with the various regulations now in existence such as HIPAA, Sarbanes Oxley, and Gramm-Leach-Bliley, and/or other regulations.

According to one embodiment, the Web browser-based document management system 100 can include an intermediate layer between structured indexing and the database. The intermediate layer allows custom modules to be provided into the document management system 100 to enable monitoring of database manipulations search requests, index submissions and other database manipulations. According to one embodiment, monitoring of database manipulation can enable various operations, performing including integrity checks on data entering the document management system 100, performing security checks before users are allowed to access selected fields, performing additional calculations for selected database operations, generating queries for calculations that are not mapped to a database via regular queries, and other operations.

According to one embodiment, a client side graphical form builder can be provided that enables users to customize features, including a graphical user interface layout, field selection and other features. According to another embodiment, a universal image viewer can be provided that supports various image sizes, including letter image sizes to engineering image sizes. The viewer can be integrated with the document management system 100.

According to yet another embodiment, the user interface can include a bird's eye view for large images. The bird's eye view can enable users to maintain an orientation of the viewing location within the large image when a separate selected viewing portion is zoomed in or out. For example, a full drawing can be provided with a small box that indicates a location within the large image. The small box can be moveable within the large image to move the zoomed viewing area.

In one embodiment, system 100 can provide an SaaS delivery model for an application to manage documents and their content. A monthly subscription fee can be obtained from a user for accessing a web browser based application hosted at a secure data facility. The user does not buy or install the software, they pay for only what they use only as long as they use it. It runs in a secure data center that the customer accesses across the internet.

In one embodiment, system 100 can provide a tree view for organizing documents. The folder names and the hierarchy are determined by the index values that were entered when the document was placed in the system. Desktop files can be dragged and dropped directly into the location in the tree where storage of the document is desired. This can open the indexing form and automatically populate the fields for the levels above where the document is stored.

In one embodiment, system 100 can include a graphical mapper tool, such as a Web Browser-based AJAX Graphical Process Map Builder, to graphically map the business process and rules within the web browser application. The tool can make use of the Asynchronous Javascript and XML (AJAX) technology. This provides the user with an experience similar to that of a desktop application.

In one embodiment, system 100 can include an integrated records management module to manage the complete document lifecycle from creation to disposition. The module can be in compliance with DoD records management standards or other regulations.

In one embodiment, system 100 can provide an automated method for importing and archiving both incoming and outgoing email messages for any email address. This is designed to assist organizations in complying with record keeping regulations. The majority of the fax server applications on the market today will route incoming faxes to specific email addresses. The same method of importing email can be applied to importing faxes.

In one embodiment, system 100 can provide users with a method for communication about documents without using external tools such as email or instant messaging. The messages can be contained within the system 100 and can be linked to the document that is the subject of the conversation.

In one embodiment, system 100 can provide portlets or other viewing features to allow views into other applications or allow other applications a view into the system. Limited access to such views can be controlled by system 100.

In one embodiment, system 100 can provide text search hit highlighting on an image. When performing a content search of a repository, the search engine can provide a list of the documents that match the search criteria. The search engine can also return the location of the hit words within the document. When the user views the image document associated with the item in the result set, the hit word can be highlighted on the image.

In one embodiment, system 100 can provide a Web browser-based index form builder. This allows the user to create their own document repositories and indexing attributes using a drag and drop index form builder that is browser based. The form builder does not require the user to download and install an application.

In one embodiment, system 100 can provide a zero client footprint. The entire application can be web browser based and does not require the user to install desktop applications or browser plugins. System 100 can provide for integration with Rsync to upload changes to files instead of the entire file in order to save file upload times and bandwidth usage. Rsync is an application that allows for uploading only the changed portions of a file. This can have a significant impact on checking in large documents that have only minor changes. The time and bandwidth savings free resource for other uses, like more users on the system 100 or less time spent waiting for the file to check in.

In one embodiment, system 100 can provide email documents from the system as attachments using the message module, but allow someone to enter an email address instead of picking a user id. System 100 also can send a link to a document to a user that is not part of the system. The individual can then temporarily view the document and optionally also check the document out, make changes and check it back in. This keeps the document in the system 100 and avoids sending a copy of the document in e-mail.

In one embodiment, system 100 can provide integration with instant messaging systems such as Skype, Trillian, Yahoo Instant Messager, and others. This allows users to send and receive messages and documents from Instant Messaging (IM) applications without having to save the file to their local disk and then sending it. In one embodiment, the messages can be entered and tracked in the system 100, while sent to a user via IM.

In one embodiment, system 100 can provide integration with various other applications including OpenOffice and other file formats and documents such as Google documents and spreadsheets so that users can store and retrieve documents directly from the other applications. System 100 provides services that are exposed via SOAP (Simple Object Access Protocol), which allows integration of virtually any other application with this one and consume the services it provides.

In one embodiment, system 100 can provide type ahead (auto complete) functionality for entering search values or index values. To save time and effort a form can be setup so that when a user is searching or indexing, the system 100 can offer suggestions based on the characters that have been typed so far.

In one embodiment, system 100 can provide desktop application integration such as through Open Document Management Architecture (ODMA). System 100 can be conformed in part to a defined standard for integrating desktop applications with document management applications that make it easier for the user to save and use documents in the system.

In one embodiment, system 100 can automatically upload new version of documents. The system 100 can keep track of documents that are being edited on the local system and automatically upload changes to the server. Other users can then view any updates that have been made. In another embodiment, system 100 can provide a menu choice in the OS to send a document to the system. System 100 can integrate the system with the desktop, so that if you right-click on a file on the desktop you can select Send To System to upload it to the server.

In one embodiment, system 100 can provide a printer driver to send image version of document to the system. The printer driver can convert the document to a collection of TIFF image pages or other formats, and automatically upload them to the system 100 and allow the user to index the document. In another embodiment, system 100 can provide a WebDav interface. This allows further integration with other products and also allows the use of Novell NetDrive, with the application. NetDrive can simulate a local hard drive so that while documents are actually stored in the system 100, it appears as if they are located on the local computer.

In one embodiment, system 100 can allow a check out of the document while leaving it on the server so it can be accessed from anywhere. For example, when a user checks out a document, it could be left on the server, but would allow the user to edit the file. This would allow the user to keep the document checked out, but have the ability to go to another computer or location and continue editing the file without having to check it back in. This could use the WebDav technology to make it appear seamless to the user.

In one embodiment, system 100 can provide a feature for comparing and merging word documents. The feature would allow multiple users to edit the same document at the same time. The system 100 would process merging all of the changes to create the new version of the document. In another embodiment, system 100 can import documents via FTP automatically. Some new copiers have the ability to scan files and upload them to an FTP site. Any document that is scanned with the copier is then automatically uploaded and stored in the system 100. In yet another embodiment, system 100 can import documents by sending via e-mail. An e-mail address can be provided to users where they can send documents. Any document that is sent to this e-mail address is automatically archived into the system 100.

While the preferred forms of the invention have been disclosed, it will be apparent to those skilled in the art that various changes and modifications can be made that will achieve some of the advantages of the invention without departing from the spirit and scope of the invention. For example, the system 100 can be configured to support various other document management system and/or content management systems. It will be apparent to those reasonably skilled in the art that other components performing the same function can be suitably substituted. Further, the methods of the invention can be achieved in either all software implementations, using the appropriate processor instructions, or in hybrid implementations that utilize a combination of hardware logic and software logic to achieve the same results. Therefore, the scope of the invention is to be determined solely by the appended claims.

We claim:

1. A method of managing documents and content, the method comprising:
providing a management application hosted in a data center; and
providing access to the management application for a user in a remote location, the access being provided by way of a web browser over the internet, wherein the management application captures, retrieves and archives the documents and content.

2. The method of claim 1, further comprising adding documents and content by way of a drag and drop interface.

3. The method of claim 1, further comprising:
obtaining indexing values from the user for each of the documents and content; and
organizing the documents and content based at least in part on the indexing values.

4. The method of claim 1, further comprising processing the documents and content according to workflow instructions generated by the user.

5. The method of claim 1, wherein the management application maintains status information regarding registration of users.

6. The method of claim 1, wherein the management application provides modification alerts to the user for changes made to each of the documents and content.

7. The method of claim 1, wherein the management application monitors user activities for at least one of logging in, searching, reading files, checking out files, checking in files, sending messages, receiving messages, viewing messages, receiving workflow items, acting on workflow items, adding documents, exporting documents, and printing.

8. The method of claim 1, further comprising delivering a message associated with a particular document or content between a plurality of users, the message being routed by the management application.

9. The method of claim 1, further comprising tracking revisions to one of the documents or content made by a plurality of users.

10. A system for managing documents and content, the system comprising:
a data center hosting a management application, the data center providing access to the management application for a user in a remote location, the access being provided by way of a web browser over the internet, wherein the management application captures, retrieves and archives the documents and content, wherein the management application obtains indexing values from the user for each of the documents and content, and wherein the management application organizes the documents and content based at least in part on the indexing values.

11. The system of claim 10, wherein the management application has a drag and drop module that adds documents and content by way of a drag and drop interface.

12. The system of claim 10, wherein the management application has a work flow engine module for processing the documents and content according to workflow instructions generated by the user.

13. The system of claim 10, wherein the management application has a presence module that maintains status information regarding registration of users.

14. The system of claim 10, wherein the management application provides modification alerts to the user for changes made to each of the documents and content.

15. The system of claim 10, wherein the management application monitors user activities for at least one of logging in, searching, reading files, checking out files, checking in files, sending messages, receiving messages, viewing messages, receiving workflow items, acting on workflow items, adding documents to the system, exporting documents from the system, and printing.

16. The system of claim 10, wherein the management application has a messaging module that delivers a message associated with a particular document or content between a plurality of users, the message being routed by the management application.

17. The system of claim 10, wherein the management application tracks revisions to one of the documents or content made by a plurality of users.

18. A computer readable program embodied in an article of manufacture comprising computer readable program instructions for managing documents and content, said program comprising:
program instructions for causing the computer to capture, retrieve and archive the documents and content;
program instructions for causing the computer to allow access by a user in a remote location, the access being provided by way of a web browser over the internet; and
program instructions for causing the computer to provide at least one of: adding documents and content by way of a drag and drop interface; obtaining indexing values from the user for each of the documents and content and organizing the documents and content based at least in part on the indexing values; processing the documents and content according to workflow instructions generated by the user; and maintaining status information regarding registration of users.

19. The program of claim 18, further comprising program instructions for causing the computer to monitor user activities for at least one of: logging in; searching; reading files; checking out files; checking in files; sending messages; receiving messages; viewing messages; receiving workflow items; acting on workflow items; adding documents; exporting documents; and printing.

20. The program of claim 18, further comprising program instructions for causing the computer to provide at least one of: delivering a message associated with a particular document or content between a plurality of users; and tracking revisions to one of the documents or content made by the plurality of users.
